(19) United States
(12) Patent Application Publication
(10) Pub. No.: US 2012/0046969 A1
(43) Pub. Date: Feb. 23, 2012

(54) Converting Medical Data to a Data Format for Exportation from a Brokerage System

(76) Inventor: Roy Schoenberg, Boston, MA (US)

(21) Appl. No.: 13/212,405

(22) Filed: Aug. 18, 2011

Related U.S. Application Data
(60) Provisional application No. 61/374,759, filed on Aug. 18, 2010.

(51) Int. Cl. G06Q 50/00

(52) U.S. Cl. 705/3

(57) ABSTRACT

A computer-implemented method includes retrieving, by a computer included in a brokerage system for determining real-time availability of medical service providers for consultations with consumers of medical services, medical data records of a consumer requesting a consultation with one of the medical service providers, with the medical data records retrieved from an source external to the brokerage system and formatted in accordance with a first data format; converting by the computer the medical data records retrieved from the source external to the brokerage system from the first data format to a second, different data format for medical data records used in the brokerage system; and exporting, by the computer system, the medical data to a medical data system used by the one medical service provider.

### CLAIM OF PRIORITY

This application claims priority under 35 U.S.C. §119(e) to provisional U.S. Patent Application 61/374,759, filed on Aug. 18, 2010, the entire contents of which are hereby incorporated by reference.

### SUMMARY

In one aspect of the present disclosure, a computer-implemented method includes retrieving, by a computer included in a brokerage system for determining real-time availability of medical service providers for consultations with consumers of medical services, medical data records of a consumer requesting a consultation with one of the medical service providers, with the medical data records retrieved from an source external to the brokerage system and formatted in accordance with a first data format; converting by the computer the medical data records retrieved from the source external to the brokerage system from the first data format to a second, different data format for medical data records used in the brokerage system; and exporting, by the computer system, the medical data to a medical data system used by the one medical service provider.

These and other embodiments can each optionally include one or more of the following features. In some embodiments, the method includes converting the medical data records from the format used by the brokerage system to a third, different format used by the medical data system; and wherein exporting includes: exporting, by the computer system, the medical data converted to the third format to the medical data system. In other embodiments, the method includes receiving the second data format for the medical data system.

In still other embodiments, the method includes tagging the second data format with data identifying the medical data system. In some embodiments, the medical data system is an electronic medical record system that is external to the brokerage system. In other embodiments, the method includes receiving data specifying one or more times for exportation of the medical data from the brokerage system to the medical data system. In still other embodiments, the method includes detecting that a current time matches at least one of one or more times for exportation of the medical data.

Other embodiments of these aspects include corresponding systems, apparatus, and computer programs, configured to perform the actions of the methods, e.g., encoded on computer storage devices.

### BRIEF DESCRIPTION OF THE FIGURES

FIG. 1 is a diagrammatic view of an engagement brokerage service.

FIG. 2 depicts a process for generating data formatting instructions for a provider practice.

FIG. 3 depicts a process for exporting medical data to a provider practice.

FIG. 4 depicts a graphical user interface that when rendered on a display device enables selection of medical data for exportation.

FIG. 5 is a block diagram of a computer (computer system) showing exemplary components that is used for the brokerage system and/or client devices.

### DETAILED DESCRIPTION

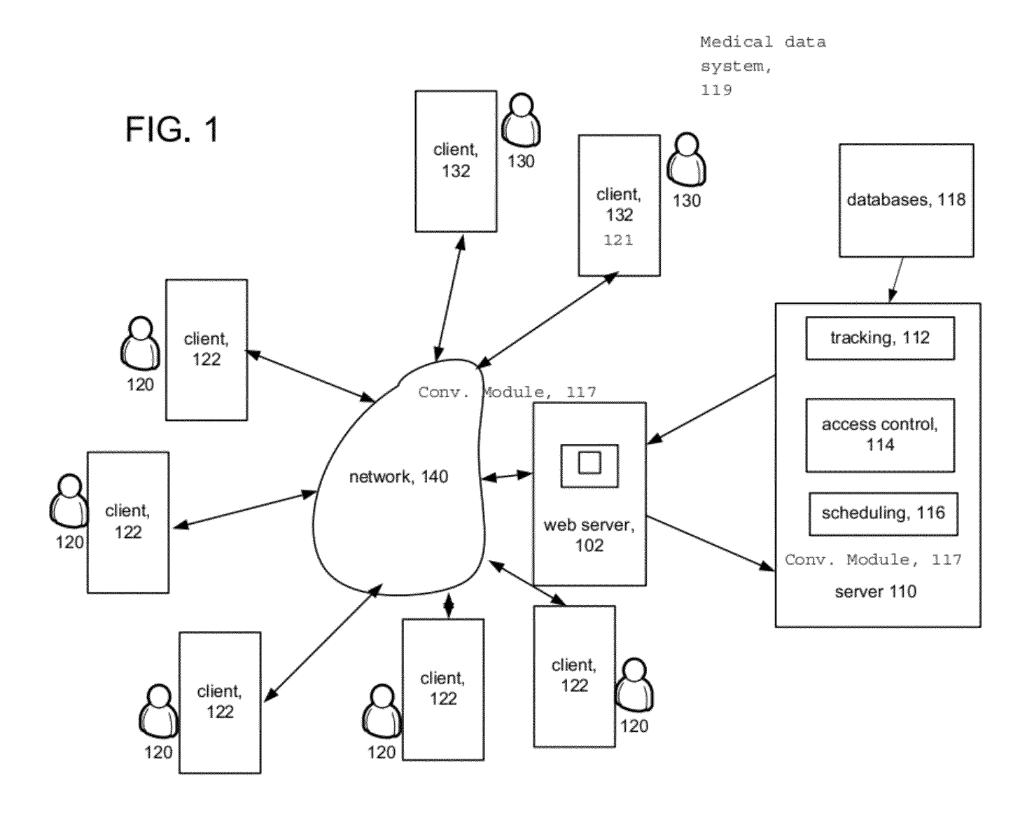

FIG. 1 shows an example system 100 implementing a brokerage service. The system 100 includes a server 110 for making connections between consumers 120, at client devices 122, including mobile devices and PDAs, and service providers 130, at client devices 132, over a network 140, e.g., the Internet or other types of networks. The server 110 operates a service running on a web server 102.

The server 110 includes an availability module 112 for tracking the availability of the service providers 130. Availability information is tracked actively or passively. In an active system, one or more of the service providers 130 provides an indication to the server 110 that the one or more service providers are available to be contacted by consumers 120 and an indication of the mode by which the provider may be contacted. In some examples of an active system, the provider's mobile device periodically provides an indication of the provider's availability (e.g., available, online, idle, busy) to the server 110 and a mode (e.g., text, voice, video, etc.) by which he is engaged. In a passive system, the server 110 presumes that the service provider 130 is available by the service provider's actions, including connecting to the server 110 or registering the provider's local phone number of the provider's mobile device with the system. In some examples of a passive system, the server 110 indicates the provider 130 to be available at all times until the provider logs off, except when the provider is actively engaged with a consumer 120.

The server 110 also includes one or more processes such as the tracking module 112 and a scheduling module 116. The server 110 accesses one or more databases 118. The components of the server 110 and the web server 102 may be integrated or distributed in various combinations.

Using the system 100, a consumer 120 communicates with a provider 130. The consumers 120 and providers 130 connect to the server 110 through a graphical user interface displayed on a mobile device and served by the web server 102 using client devices 122 and 132, respectively. Client devices 122 and 132 include any combination of mobile devices, PDAs, cellular phones, computer systems, and so forth. The client devices 122 and 132 enable the consumers 120 to input and receive information as well as to communicate via video, audio, and/or text with the providers 130.

Client device 132 is associated with a provider practice, including, e.g., a medical office of a physician. Client device 132 implements an electronic medical record (“EMR”) service 121 for storing, processing, analyzing and inputting medical data. EMR service 121 stores the medical data in client device 132 in accordance with a data format, e.g., an EMR format. Client device 132 is used by the provider practice as a medical data system for the storage and/or for the viewing and/or for the retrieval of medical information.

Server 110 also stores in database 118 medical data, e.g., data specifying a transcription of a consultation between a consumer and a physician, data specifying physician's notes following an engagement with a consumer, data specifying a consumer's diagnosed medical conditions, and so forth.

Server 110 stores the medical data in database 118 accordance with another format, including, e.g., a brokerage system format. The brokerage system format differs from the EMR format. The brokerage system format and the EMR format each include various types of formats, including, e.g., a Hypertext Markup Language (HTML) format, a portable document format (PDF), a continuity of care record (CCR) format, a continuity of care document (CCD) format, and a text format.

Service provider 130 engages in consultations with consumers 120 through server 110 and also through provider practice associated with client device 132. When service provider 130 engages in consultations through server 110, medical data pertaining to the consultation is stored in database 118 in accordance with the brokerage system format. When service provider 130 engages in consultations through the provider practice, medical data pertaining to the consultation is stored in client device 132 in accordance with the EMR format.

Server 110 includes conversion module 117 to convert medical data stored in database 118 to various formats. Conversion module 117 converts the medical data stored in database 118 from the brokerage system format to the EMR format, e.g., using techniques that are commonly known in the art. Conversion module 117 sends the medical data in accordance with the EMR format to client device 132, e.g., to promote continuity of medical care among provider practices and server 110.

System 100 also includes medical data system 119, e.g., which is a source of medical data (including medical data records) for server 110. Server 110 retrieves medical data records and/or medical data from medical data system 119. Medical data records include a type of medical data that has been formatted to be presented to a user as a record. Medical data system 119 formats the medical data records in accordance with a data format, including, e.g., a medical data system format. Following retrieval of the medical data records, server 110 executes conversion module 117 to convert the medical data records from the medical data system format to the brokerage system format. When client device 132 sends to server 110 a request for exportation of the medical data records to client device 132, conversion module 117 converts the medical data records from the brokerage system format to the EMR format. The EMR format may be the same format as the brokerage system format, in which example, conversion module 117 does not perform an additional conversion prior to exporting the medical data records to client device 132.

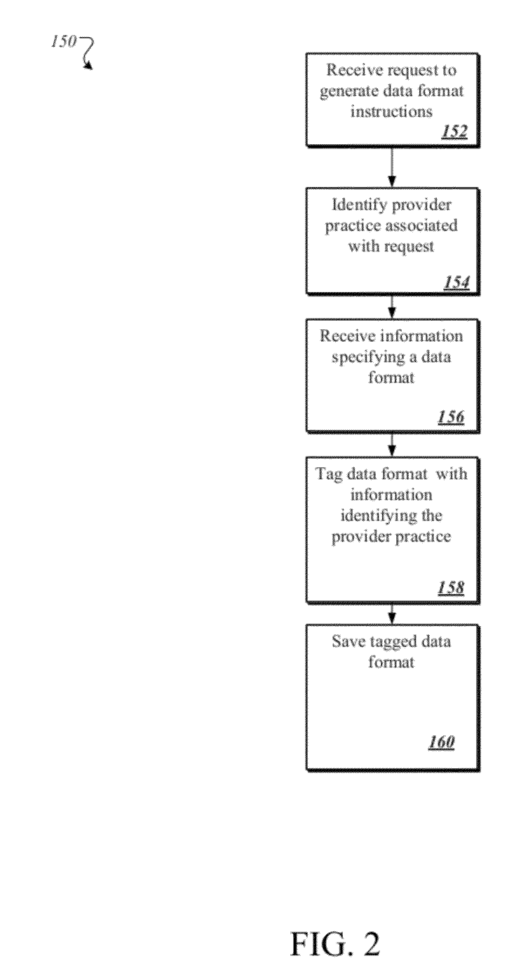

Referring to FIG. 2, server 110 implements process 150 for generating data formatting instructions for a provider practice. In operation, server 110 receives (152) a request to generate data formatting instructions. In response, server 110 identifies a provider practice associated with the request. Server 110 identifies the provider practice that sent the request using various techniques, including, e.g., parsing contents of the request for a provider practice identifier, determining data uniquely identifying client device 132 that sent the request, prompting the sender of the request for data identifying the provider practice, and so forth.

Server 110 also receives (156) data specifying a data format used by the provider practice, e.g., a data format using by EMR service 121 running on client device 132. Brokerage system tags (158) the data format with the data identifying the provider practice. Generally, tagging includes generating a relationship between two items of data. Server 110 also saves (160) the tagged data format in database 118.

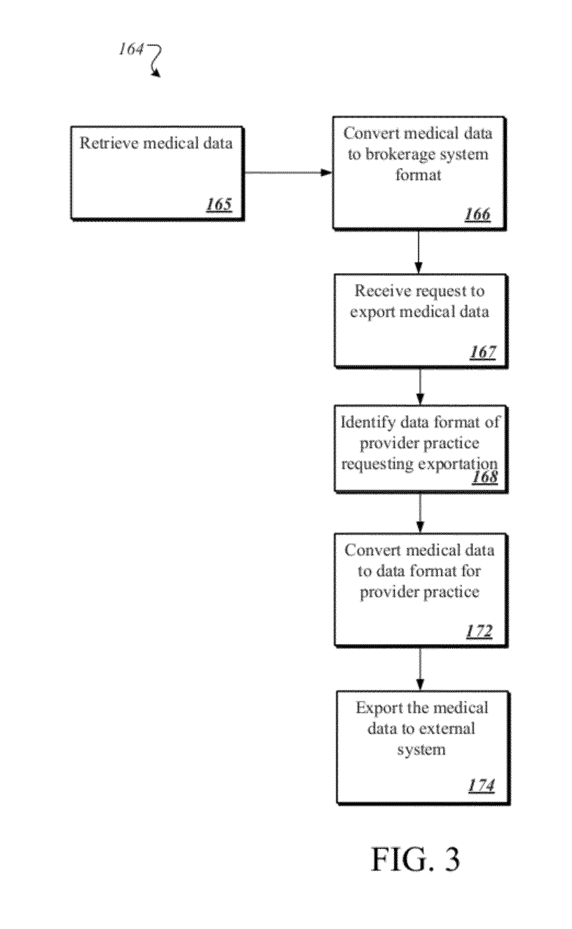

Referring to FIG. 3, server 110 implements process 164 to convert medical data from one format to another format for exportation from server 110. In operation, server 110 retrieves (165) medical data from medical data system 119, e.g., in accordance with identities of consumers presently engaged in a consultation with service providers, at scheduled times, and so forth. Conversion module 117 converts (166) the retrieved medical data from the medical data system format to the brokerage system format, e.g., a CCR. A service provider uses the medical data in the brokerage system format during consultations with consumers.

Server 110 receives (167) a request (not shown) to export medical data from server 110 to client device 132. The request to export medical data is sent from client device 132. Using data formatting instructions, server 110 identifies (168) the data format associated with the provider practice that sent the request to export medical data. Server 110 identifies a data format for a provider practice using a mapping of provider practices to data formatting instructions. Using the mapping and the data identifying the provider practice that sent the request, server 110 identifies data formatting instructions for the provider practice.

Using techniques commonly known in the art, conversion module 117 converts (172) the medical data from the brokerage system format to a format used by EMR service 121 (e.g., the EMR format). Conversion module 117 exports (174) the medical data formatted in accordance with the EMR format to client device 132.

In an example, the brokerage system format includes a CCR. Conversion module 117 generates the CCR to promote a conversion of the medical data from the brokerage system format to the EMR format with increased accuracy, e.g., relative to an accuracy provided by directly converting the medical data from the brokerage system format to the EMR format. CCR is a format that is widely used in the medical industry, and the industry has developed many conversion modules for converting medical data from one format into a CCR and/or for converting a CCR into another format.

Conversion module 117 exports medical data at various times, including, e.g., following receipt of a request, at scheduled times and/or time intervals, in real-time as server 110 collects medical data, and so forth. In an example, service provider 130 specifies that medical data pertaining to consultations among service provider 130 and consumers 120 is exported to client device 132 in real-time, e.g., as service provider 130 engages in a consultation with consumers 120.

In another example, service provider 130 specifies that the medical data pertaining the consultations among service provider 130 and consumers 120 is exported to client device 132 in accordance with scheduled times, including, e.g., daily, once a week, once a month, and so forth.

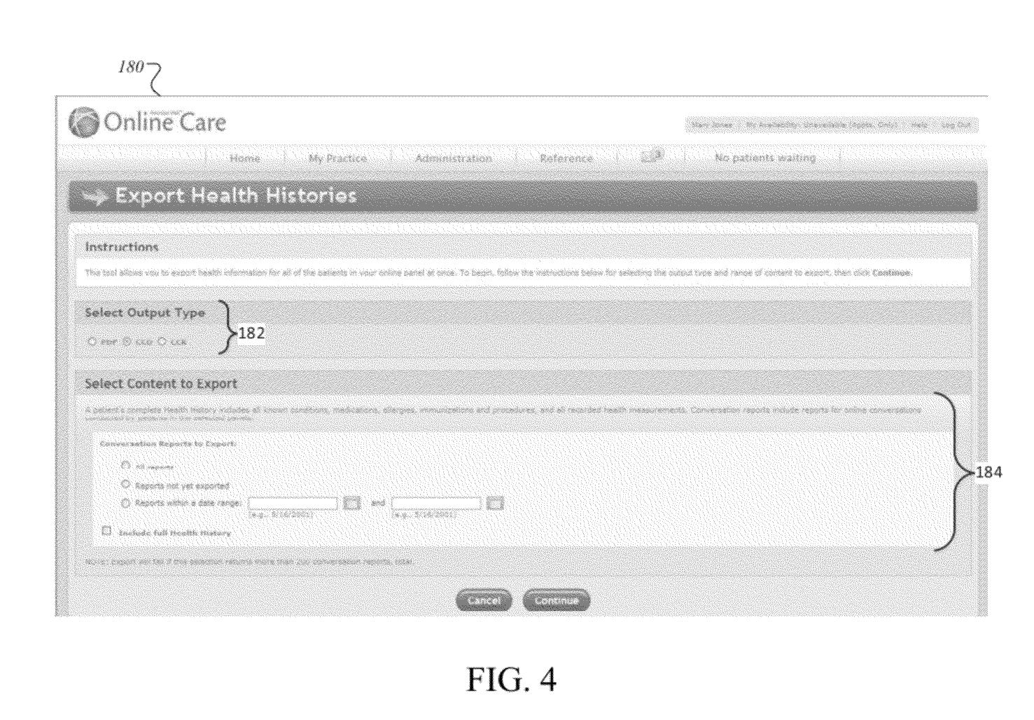

Referring to FIG. 4, server 110 generates graphical user interface 180 to promote continuity of medical care among server 110 and other, external systems (e.g., client device 132). Graphical user interface 180 includes portion 182 for selecting a data format for the medical data to be exported to client device 132.

Graphical user interface 180 also includes portion 184 for selection of the medical data to be exported to client device 132. Through portion 184, a user selects various types of medical data for exportation, including, e.g., medical data associated with a time period, medical data associated with various patients, medical data that has not been exported, and so forth. Portion 184 of graphical user interface 180 also provides a user with an option of selecting a portion of a medical data record for exportation and/or for selecting an entire medical data record for exportation. Following selection of the medical data for exportation and the data format, conversion module 117 converts the medical data from the brokerage system format to the selected format.

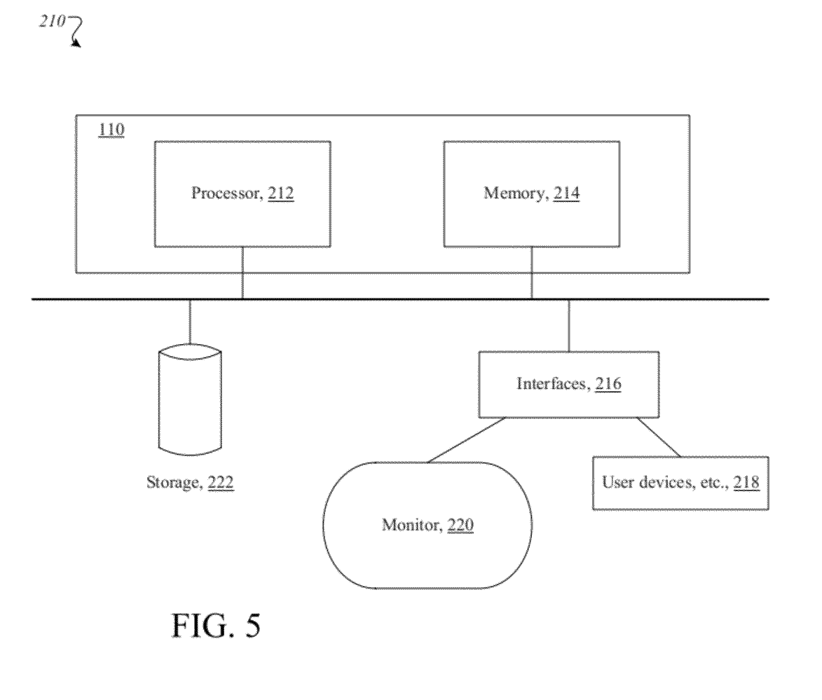

FIG. 5 is a block diagram of components 210 of the engagement brokerage system. Client devices 218 is any sort of computing device capable of taking input from a user and communicating over a network (not shown) with server 110 and/or with other client devices. For example, client device 218 is a mobile device, a desktop computer, a laptop, a cell phone, a personal digital assistant (“PDA”), a server, an embedded computing system, a mobile device and so forth. Client devices 218 include monitor 220, which renders visual representations of interface 216.

Server 110 is any of a variety of computing devices capable of receiving information, such as a computer system, a desktop computer, a laptop, a cell phone, a rack-mounted server, and so forth. Server 110 may be a single server or a group of servers that are at a same location or at different locations,

In an example, server 110 is a brokerage system for determining real-time availability of service providers for consultations with consumers. In this example, a part of server 110 includes a computer system for implementing processes 150 (FIG. 2), 164 (FIG. 3).

Server 110 can receive information from client device 218 via interfaces 216, including, e.g., graphical user interfaces. Interfaces 216 is any type of interface capable of receiving information over a network, such as an Ethernet interface, a wireless networking interface, a fiber-optic networking interface, a modem, and so forth. Server 110 also includes a processor 212 and memory 214. A bus system (not shown), including, for example, a data bus and a motherboard, is used to establish and to control data communication between the components of server 110.

Processor 212 may include one or more microprocessors. Generally, processor 212 may include any appropriate processor and/or logic that is capable of receiving and storing data, and of communicating over a network (not shown). Memory 214 can include a hard drive and a random access memory storage device, such as a dynamic random access memory, machine-readable media, or other types of non-transitory machine-readable storage devices.

Components 210 also include storage device 222, which is configured to store information collected through the brokerage system during a service provider's consultation with a consumer. In another example, storage device 222 is also configured to receive information from a physician's physical office and to integrate the information associated with the physical office into the brokerage system so that the brokerage system may access and may use the information associated with the physical office space.

Embodiments is implemented in digital electronic circuitry, or in computer hardware, firmware, software, or in combinations thereof. Apparatus of the invention is implemented in a computer program product tangibly embodied or stored in a machine-readable storage device and/or machine readable media for execution by a programmable processor; and method actions is performed by a programmable processor executing a program of instructions to perform functions and operations of the invention by operating on input data and generating output. The invention is implemented advantageously in one or more computer programs that are executable on a programmable system including at least one programmable processor coupled to receive data and instructions from, and to transmit data and instructions to, a data storage system, at least one input device, and at least one output device. Each computer program is implemented in a high-level procedural or object oriented programming language, or in assembly or machine language if desired; and in any case, the language is a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Computer readable storage media are storage devices. Storage devices suitable for tangibly embodying computer program instructions and data include all forms of memory devices, including by way of example semiconductor memory devices, such as volatile RAM, or non-volatile memory devices such as EPROM, EEPROM, and flash memory devices; magnetic disks such as internal hard disks and removable disks; magneto-optical disks; and CD_ROM disks. Any of the foregoing is supplemented by, or incorporated in, ASICs (application-specific integrated circuits).

Other embodiments are within the scope and spirit of the description claims. For example, due to the nature of software, functions described above is implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprising:
retrieving, by a computer included in a brokerage system for determining real-time availability of medical service providers for consultations with consumers of medical services, medical data records of a consumer requesting a consultation with one of the medical service providers, with the medical data records retrieved from an source external to the brokerage system and formatted in accordance with a first data format;
converting by the computer the medical data records retrieved from the source external to the brokerage system from the first data format to a second, different data format for medical data records used in the brokerage system; and
exporting, by the computer system, the medical data to a medical data system used by the one medical service provider.

2. The computer-implemented method of claim 1, further comprising:
converting the medical data records from the format used by the brokerage system to a third, different format used by the medical data system;
wherein exporting comprises:
exporting, by the computer system, the medical data converted to the third format to the medical data system.

3. The computer-implemented method of claim 2, further comprising:
receiving the second data format for the medical data system.

4. The computer-implemented method of claim 3, further comprising:
tagging the second data format with data identifying the medical data system.

5. The computer-implemented method of claim 1, wherein the medical data system is an electronic medical record system that is external to the brokerage system.

6. The computer-implemented method of claim 1, further comprising:
receiving data specifying one or more times for exportation of the medical data from the brokerage system to the medical data system.

7. The computer-implemented method of claim 1, further comprising:
detecting that a current time matches at least one of one or more times for exportation of the medical data.

8. A computer program product tangibly stored on a computer readable storage media, the computer program product comprising instructions for causing a processor to perform operations comprising:
retrieving, by a computer included in a brokerage system for determining real-time availability of medical service providers for consultations with consumers of medical services, medical data records of a consumer requesting a consultation with one of the medical service providers, with the medical data records retrieved from an source external to the brokerage system and formatted in accordance with a first data format;
converting by the computer the medical data records retrieved from the source external to the brokerage system from the first data format to a second, different data format for medical data records used in the brokerage system; and
exporting, by the computer system, the medical data to a medical data system used by the one medical service provider.

9. The computer program product of claim 8, wherein the operations further comprise:
converting the medical data records from the format used by the brokerage system to a third, different format used by the medical data system;
wherein exporting comprises:
exporting, by the computer system, the medical data converted to the third format to the medical data system.

10. The computer program product of claim 9, wherein the operations further comprise:
receiving the second data format for the medical data system.

11. The computer program product of claim 10, wherein the operations further comprise:
tagging the second data format with data identifying the medical data system.

12. The computer program product of claim 8, wherein the medical data system is an electronic medical record system that is external to the brokerage system.

13. The computer program product of claim 8, wherein the operations further comprise:
receiving data specifying one or more times for exportation of the medical data from the brokerage system to the medical data system.

14. The computer program product of claim 8, wherein the operations further comprise:
detecting that a current time matches at least one of one or more times for exportation of the medical data.

15. An electronic system comprising:
a processor; and
a computer program product tangibly stored on a computer readable storage media, the computer program product comprising instructions for causing the processor to perform operations comprising:
retrieving, by a computer included in a brokerage system for determining real-time availability of medical service providers for consultations with consumers of medical services, medical data records of a consumer requesting a consultation with one of the medical service providers, with the medical data records retrieved from an source external to the brokerage system and formatted in accordance with a first data format;
converting by the computer the medical data records retrieved from the source external to the brokerage system from the first data format to a second, different data format for medical data records used in the brokerage system; and
exporting, by the computer system, the medical data to a medical data system used by the one medical service provider.

16. The electronic system of claim 15, wherein the operations further comprise:
converting the medical data records from the format used by the brokerage system to a third, different format used by the medical data system;
wherein exporting comprises:
exporting, by the computer system, the medical data converted to the third format to the medical data system.

17. The electronic system of claim 16, wherein the operations further comprise:
receiving the second data format for the medical data system.

18. The electronic system of claim 17, wherein the operations further comprise:
tagging the second data format with data identifying the medical data system.

19. The electronic system of claim 15, wherein the medical data system is an electronic medical record system that is external to the brokerage system.

20. The electronic system of claim 15, wherein the operations further comprise:
receiving data specifying one or more times for exportation of the medical data from the brokerage system to the medical data system.
